(19) United States
(12) Patent Application Publication
(10) Pub. No.: US 2012/0078673 A1
(43) Pub. Date: Mar. 29, 2012

(54) DYNAMIC QUEUEING AND MANAGEMENT SYSTEM

(76) Inventors: John Koke, Duncan, SC (US); Stephen D. Smith, Williamsburg, MA (US); Charles R. Sperry, Leeds, MA (US); Vincent A. Piucci, Spencer, MA (US)

(21) Appl. No.: 12/892,086

(22) Filed: Sep. 28, 2010

(51) Int. Cl. G06Q 10/00; G06Q 30/00

(52) U.S. Cl. 705/7.13; 705/26.81; 705/28

(57) ABSTRACT

The present disclosure describes a dynamic queueing and management system. The system utilizes the desired completion time in determining where to place new orders into the queue of orders to be fulfilled. If the desired completion time changes, the position of the corresponding order is adjusted within the queue. In some embodiments, the desired completion time is determined based on the location of the customer, either within the store or en route to the store. The queueing and management system may also separate the order input function from the order fulfillment and delivery functions. This may optimize each part of the process and allow faster service.

### BACKGROUND OF THE INVENTION

In today's supermarkets, the majority of deli orders are made and fulfilled manually. Often, a customer enters a supermarket and proceeds to the deli counter. The customer generally obtains a numbered ticket from a dispenser and then waits their turn in the queue. Once their number reaches the top of the queue, the deli employee calls their number, and the customer places their order while they wait. Often, when the queue is lengthy, one may take a number and start shopping, hoping to return back to the deli at a time close to when their number will be called. Unfortunately, this is often an inexact practice. Often, customers return to the deli counter too soon, when there is still significant wait time, or too late, after their number has already been called.

In an effort to reduce these known issues, many supermarkets have incorporated electronic kiosks. At this kiosk, the customer can enter their entire order and receive a number. The customer is then free to continue their shopping, knowing that the deli has the information needed to complete their order. At a later time, the customer returns to the deli counter and picks up their completed order. Technologies exist to allow orders to be placed remotely, using a mobile device or an internet connection, as well telephone ordering.

While the use of kiosks eliminates the need for the customer to wait in line, there are numerous lingering issues. For example, the integration of these kiosk orders with those of waiting customers can be problematic. If waiting customers believe that previously submitted kiosk orders are being given priority over them, the waiting customer may view this treatment as unfair, and may vocalize their displeasure. To counteract this behavior, the deli employees may choose to serve the waiting customers first, delaying the submitted kiosk orders. However, if a customer, who had previously submitted an order and has since finished shopping, returns to the deli counter to find that their order has not been processed, that customer may also become upset.

One proposed solution to this problem has been to merge the two queues (waiting customers and submitted electronic orders) into a single queue, serviced on a first-come, first served basis. However, such a solution may not be fair. Customers who have left the deli counter to continue their shopping need not have their orders serviced immediately, as they are not waiting for them.

Current systems fail to adequately address these issues. Therefore, a dynamic queueing and management system that addresses these and other shortcomings would be beneficial.

### SUMMARY OF INVENTION

The problems of the prior art are addressed by the dynamic queueing and management system of the present disclosure. The system utilizes the desired completion time in determining where to place new orders into the queue of orders to be fulfilled. If the desired completion time changes, the position of the corresponding order is adjusted within the queue. In some embodiments, the desired completion time is determined based on the location of the customer, either within the store or en route to the store. In some embodiments, a separate queue is used to maintain individual items to maximize the efficiency of the fulfillment staff.

The queueing and management system may also separate the order input function from the order fulfillment and delivery functions. This may optimize each part of the process and allow faster service. For example, by monitoring the length of the queue, the current order demand and the fulfillment staffing levels, the system can also determine whether additional personnel need to be activated to meet customer demand. In some embodiments, the system also monitors the inventory levels and is able to notify the appropriate department when supply of a particular item drops below a predetermined level.

### BRIEF DESCRIPTION OF DRAWINGS

FIG. 1 is a schematic showing a representative embodiment of the present invention.

FIG. 2 is a schematic showing a representative embodiment of the software modules of the present invention.

FIGS. 3A-B are schematics showing the reordering of orders, based on the items in those order.

FIG. 4 is a schematic showing the interaction between the Order and Item queues.

### DETAILED DESCRIPTION OF THE INVENTION

As described above, the queuing systems used for deli counters in most supermarkets have shortcomings. While the current invention describes a queueing and management system for deli applications, it should be obvious that the present invention can be utilized for other applications, particularly in retail, or wherever real-time order fulfillment is needed, such as warehouse operations. Furthermore, within the supermarket, the current invention may be used for any orderable or customizable item, such as salads, bakery, seafood and butcher counter orders.

For the purposes of this disclosure, an “order” is defined as a single item or multiple items that are requested by the consumer or customer. An “item” is a request for a single food, including its slice thickness, packaging preferences, etc. In the example of the deli, an example of a single item could be one half pound of roast beef, sliced medium in thickness. An example of multiple items may be a half pound of roast beef plus a quarter pound of honey ham plus a pound of American cheese. In addition, a customer may request special packaging, such as shingled deli orders or separator sheets. “Fulfillment”, as defined in this disclosure, may comprise selecting the item, slicing, weighing, wrapping, labeling and any other functions necessary to prepare an order for pick up by, or delivery to, the customer. “Fulfillment” may include manual preparation as is commonly done today, an automated fulfillment system, or a combination of both.

An advantage of the queueing and management system of the current invention is the ability to place the complete order at one time, then continue shopping while the order is being prepared. This is substantially more time and labor efficient than the traditional method of waiting in line at the deli counter until an associate is available, then ordering one item, waiting for its preparation, ordering the next item, and repeating this process until the entire order is fulfilled.

With the queueing and management system of the current invention, orders can be received through a variety of sources. These include but are not limited to:
Orders placed at the deli counter in the same manner as is done today
Orders placed with sales associates located in front of the deli counter, or in other locations within the store
Orders placed through an automated kiosk that is located within the store
Orders placed from a remote location using an Internet connection
Orders placed remotely using applications available on mobile devices, such as smart phones, PDAs, etc.
Orders placed over the telephone
Immediate sample request order by associate working with customer (which may be considered a high priority)
   All of these aforementioned technologies are commercially available and the ability to place an order using any of these technologies is known to those skilled in the art. As new communication technologies emerge, the system can be adapted to accept orders from them as well.

As noted above, currently, queue management for deli counters is based on a “first come, first served” basis. In addition, orders entered via kiosks are introduced into the queue in various ways; most of which are inefficient and unfair to either those waiting in line or those using the kiosk.

Another issue associated with queues is differentiating between different types of customers. For example, many supermarkets offer loyalty programs. Customers who frequent a particular store or chain are given certain privileges that are not available to periodic or sporadic visitors to that store. For example, certain supermarkets offer special discounts to customers having a special loyalty card or identifier. These discounts may be associated with products sold at the store, or at participating merchants. With the current invention, another privilege that may be bestowed on a loyal customer is shorter wait times at the deli, meat, bakery or seafood counters.

The present invention describes a queueing and management system, which fulfills orders in the order in which they are needed, rather than when they are placed. This queueing and management system uses desired completion time to generate the queue of orders. In addition, the queueing and management system utilizes various indications of desired completion time in determining the queue order. The processing of orders is based on at what time the order is actually needed or desired by the customer. Other features of the system will be described later.

In some embodiments, when an order is placed, the desired pick up time will be estimated and entered into the system. If the order is placed at the service counter or through the in-store kiosk, the customer may be asked whether they intend to wait at the deli counter, or continue to shop. In some embodiments, if the customer intends to continue shopping, they may be asked to estimate how long they intend to shop. If the order is placed from a source external to the store (i.e. through the internet or a mobile device app), an estimated pick up time may be requested by the system.

As stated above, the queue will be managed based on the time the order is needed and not necessarily based on the time the order is placed. Individual orders will be issued for fulfillment based on several factors, such as desired pick up time and current workload so that they will be ready for the customer at the correct time.

In some embodiments, if a customer is going to wait for their order, that order may be moved toward the top of the queue, generally on a first come first served basis of customers that are waiting. Orders with future fulfillment times will be queued so that they will be ready by the desired time. The system can estimate fulfillment time for each order, and will monitor fulfillment workload. With this information, the queue can be dynamically monitored and rearranged to optimize order delivery.

The placement of orders within the queue can be modified dynamically if a real or potential change in the desired completion time is detected. For example, in some embodiments, a means of tracking a customer's location in the store could be incorporated. Tracking devices are commonly available, and can utilize Video, RFID, a tracking beacon, GPS or other means to determine a customer's location in the store. These devices can be incorporated into a shopping cart, can be a pager-like unit handed to the customer, or any other means that can monitor their location and report it back to the management system. If the location of the customer indicates that they are approaching the end of their shopping trip, their order can be expedited toward the top of the queue. For example, knowing that most customers shop by moving from one aisle to the adjacent aisle in a single direction, the system can monitor a customer's progress as they shop. When a customer reaches one end of the store (for example, the aisle farthest away from the deli counter), the system can anticipate that the customer has finished shopping and will be returning soon to the deli counter. In another embodiment, the customer may start shopping farthest from the deli counter and work back towards the deli counter. The system can also estimate the speed of the customer as they shop. The system can identify these and other shopping behaviors and continuously update the desired completion time.

In some embodiments, to improve the customer experience, the completed order may be made available at or near the checkout or cashier. This allows the customer to simply move to the checkout rather than returning to the deli counter to pick up their order. A tracking device, such as that described above, can detect that the customer has moved toward the checkout area. Alternately, the customer may identify themselves to the cashier.

Other methods of estimating completion time may be used as well. For example, it is possible to identify the geographic location of a cell phone using currently known means. Thus, if the customer places an order remotely, such as by cell phone or by internet, and supplies the system with the cell phone number, it may be possible for the system to track the customer's progress en route to the store. As the customer nears the store, their order's position in the queue may be improved.

Of course, other methods of estimating desired completion time can be utilized. For example, those placing order electronically, such as at a kiosk or via the internet, may be prompted to enter a desired completion time. The system can then use this desired completion time to place the order in the appropriate position within the queue.

In summary, the dynamic reprioritization of orders within the queue can be triggered by, but is not limited to:
Customer location in the store as described above
Customer arriving at or nearing the check-out
Customer arrival in the store, as in the case of mobile device or internet orders
Customer return to the deli counter

Fulfillment time may also be utilized in the generation of an order's placement within the queue. For example, fulfillment times for all orders must be estimated in order to calculate when any particular order may be completed. For example, if the system calculates that an order's desired completion time is in 20 minutes, it must estimate the fulfillment time of each order currently in the queue to determine where to place this new order. Estimation of fulfillment time may be based on the number of items requested, the quantity of each of these items (for example, a pound of roast beef, sliced thin may take more time to fulfill than 4 slices of cheese), and other factors. This estimation may be based on empirical data, such as based on actual times required to fulfill past orders, or can simply be estimated. Empirical data may include type of item, quantity, thickness, assigned slicing device, staff member, etc. Other methods of estimating fulfillment time may also be used and are within the scope of the invention.

Estimated fulfillment time can also be used as a factor when determining where to position orders in a queue. For example, assume that two orders are placed which have nearly the same desired completion time. One order is for a single item, while the other order contains many items. By prioritizing the smaller order ahead of the larger order (even if its desired completion time is later), the best result may be achieved. The smaller order may be available earlier than its desired completion time, with little to no impact on the completion time of the larger order. However, had the larger order been prioritized first (due to an earlier desired completion time), the smaller order would have been late. Therefore, the system may utilize information other than simply desired completion time when placing orders in the queue.

In addition, the queue ordering algorithm may include preferential customer prioritization. For example, a customer's loyalty card can be scanned at the time an order is placed. The more frequent, or preferred, customers may receive priority and be moved up in the queue for faster service. Such treatment is especially important when the customer chooses to wait at the counter for their order.

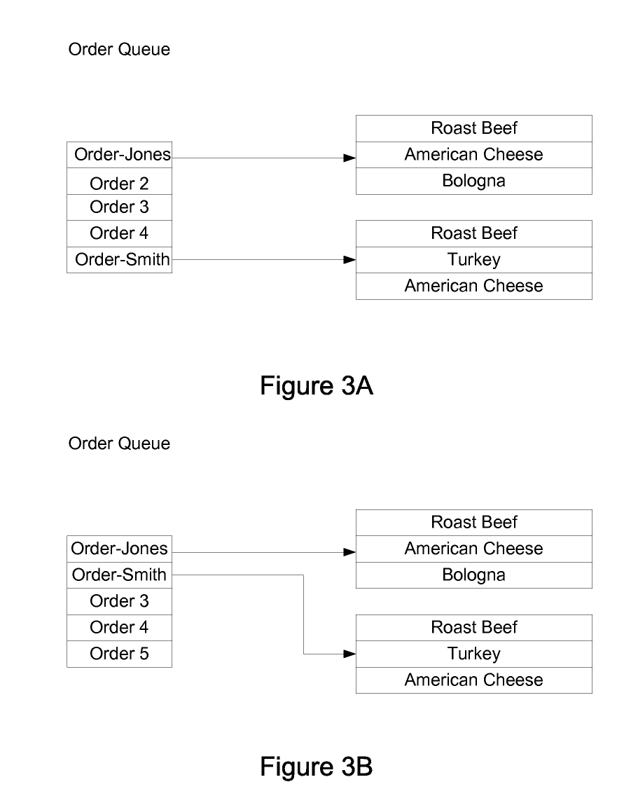

Another feature of the system is the ability to optimize the fulfillment efficiency of the entire operation by consolidating like item types. For example, if there are multiple customer orders in the queue for the same item and one of those orders is approaching its desired completion time, the system may re-prioritize multiple orders so that the preparation of that item can be optimized. Specifically, assume that the current order at the top of the queue includes roast beef, ham and cheese. If other orders located near the top of the queue also contain one or more of these items, the system may move these orders to the top of the queue to allow the staff to work more efficiently. FIG. 3A graphically shows an example where multiple orders are in the Order queue, and the linkage to the items in those orders is shown according to one embodiment. In this example, there are five orders in the Order Queue; two being of particular interest, the order from customer Jones and the order from customer Smith. The orders between these two are numbered to represent their place in the Order Queue (i.e. Orders 2-4). In this embodiment, the system determines that there is significant overlap between the items in Order Jones and Order Smith (i.e. both have Roast Beef and American Cheese). To optimize the efficiency of the fulfillment staff, the system may move Order Smith up in the Order queue so that it is immediately behind Order Jones, as shown in FIG. 3B. Note that this necessarily moves the other orders, which were previously in positions 2-4, down to positions 3-5. Thus, the meats and cheese used for Order Jones may already be readily available to the fulfillment staff for use with Order Smith.

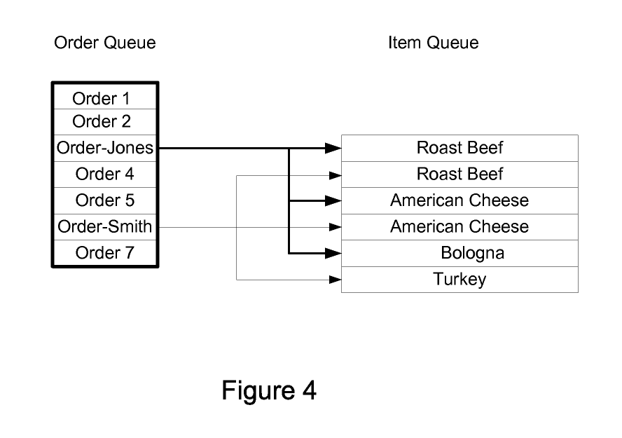

In some embodiments, the queue manager may manage a series of individual queues. For example, one queue may be the Order queue which will keep track of the orders and when they are required for delivery, as described above. The individual items that are contained within the currently pending customer orders in the Order queue may be managed in a second Item queue. Creating a second queue, which is independent from but linked to the Order queue, allows the system to sequence like items from different orders right after each to eliminate or minimize the non-value added tasks of finding the product, unwrapping, loading the product on the slicer and then storing the product again after every item is prepared. For example, assume that there are multiple orders in the Order Queue, and two of those orders, one (Order Jones) requesting roast beef, American cheese, and bologna, and the second (Order Smith) requesting roast beef, turkey and American cheese, the system will attempt to optimize the operation by sequencing the like items together in the item queue (i.e. roast beef, roast beef, American cheese, American cheese, bologna, and turkey). FIG. 4 shows multiple orders in an Order Queue. The two orders of particular interest (Jones and Smith) are named accordingly, while the other orders are named according to their position in the Order Queue. In this embodiment, a second Item Queue has been added. The items associated with Orders 1-2,4-5 and 7 are not shown for clarity. Note that it is not necessary to accelerate Order Smith in the Order queue in order to aggregate like items. Note that items in the Item queue are linked to their associated Order, so that the system can be aware of the completion of particular items of a larger order. In the above example, Order Smith (roast beef, turkey and American cheese) may be directly behind Order Jones in the Order queue. In other embodiments, Order Smith may be behind Order Jones, as shown in FIG. 4. Thus, the order of processing the items in the order as stated above is the most efficient way to complete both orders quickly.

In other embodiments, the second order (Order Smith) may be well behind the first order (Order Jones) in the Order queue. As a result, the Item queue may accelerate the processing of the roast beef and American cheese orders to maximize efficiency as explained above. However, the turkey item may not be processed until the second order (Order Smith) reaches the top of the Order queue. In this case, it is important to associate the previously prepared roast beef and American cheese with this later order. When the second order (Order Smith) comes to the top of the queue, the system may inform the fulfillment staff that the roast beef and American cheese were previously prepared. It may also provide some identification number associated with each of these completed items so that the fulfillment staff can readily find these items.

Depending on the size of the operation and the number of staff and slicers available, the item queue may be further divided into individual slicer and or staff member queues to sequence the items by slicer and or staff member in the most efficient manner. The system maintains the link between individual items and orders in the order queue and ensures that all items are completed with the required delivery time. The system will provide a means to identify the item to the order either by order number, customer name, or other unique identifying means. In the case of multi-item orders the individual items will have to be combined to complete the full order. A location (for example a slot number in a multi-slot rack system) may be assigned to the order and the individual items will be placed in that slot as they are completed. When the last item is complete, the staff will be notified that the order is complete and ready for delivery. A means may be provided either through a screen terminal or printout to confirm the items contained in the order as a final quality assurance check before delivery to the customer.

An additional advantage of the current invention is the ability to separate labor functions. These labor functions may include a “front end” function for ordering and customer service, and a “back end” function for order fulfillment and delivery. The “back end” function can even take place in a separate location that is set up and organized for greatest efficiency. Fulfillment can comprise selecting the item, slicing, weighing, wrapping, labeling and any other functions necessary to prepare an order for pick up by, or delivery to, the customer. The fulfillment may include manual preparation as is commonly done today, an automated fulfillment system, or a combination of both. In this way, the customer service associate's full attention is with the customer, which makes a more pleasant shopping experience. Likewise, the fulfillment staff's full attention is on preparing orders, making that process more efficient.

The system also monitors fulfillment in real-time, allowing it to track the performance and efficiency of the fulfillment staff. The system can monitor and adapt to the current performance of the staff.

In some embodiments, the estimated fulfillment time can be dynamically altered based on the performance of the current staff. For example, the estimated fulfillment time of a particular item may be changed based on the average actual fulfillment times measured over the past time period. In addition, the average fulfillment time of each order may be tracked and used to generate a management report. For example, a report may indicate that the fulfillment time for a particular staff member is much greater than that of the other members. This report would alert management of this fact, and may necessitate a review of that staff member's performance.

In some embodiments, the system receives input concerning the current staffing levels. For example, the system may be aware of the fulfillment and/or order staff, as well as the members that are currently on duty. The system also has visibility to the length of the queue, as well as to the queue length trend (i.e. is the queue continuously getting longer or shorter?). In addition, since the system estimates the completion time of each order, it can estimate the current order demand, which is defined as the time required to complete every order currently in the queue. In other words, each order has a number of items, where the fulfillment time of each can be estimated. By summing all of these item fulfillment times together, it is possible to estimate the amount of time needed to complete all orders in the queue. In some cases, when this time is divided by the number of fulfillment staff members currently working, a calculation of total elapsed time required can also be made. Based on these parameters, the system can interpret current and future workload and compare it to the fulfillment and/or order staffing level.

If the system notes a discrepancy between the workload and the staffing level, it can notify the staff of potential adjustments. For example, if the current order demand is greater than the current staff can process in the necessary time, the system may alert the staff that the current staff cannot keep up with demand, and more help is needed. For example, using the technique described above, the system may calculate that with 2 staff members, the total elapsed time to fulfill all orders in the queue is greater than a predetermined threshold. In this case, the system may provide notification of this discrepancy. In another case, the total elapsed time required to fulfill all order in the queue may be less than a second predetermined threshold, thereby indicating that too many staff members are currently working. In some embodiments, the system can send an alert to relocate the available staff as necessary. For example, if there is not enough capacity for the current work load in deli fulfillment, deli staff may be relocated within the deli, or someone from another department (such as produce, seafood or meat) can be called to the deli counter. In some embodiments, members of the fulfillment staff who are on break or off duty may receive an alert by way of pager, text to their mobile phone, or other means, asking them to return to the deli counter. The system may also predictively delay breaks for the fulfillment staff, knowing that breaks should not be allowed when the current order demand is too great.

Furthermore, the system may be aware that all available resources are currently in use, and current demand to deliver items cannot be met in the desired time. In this case, the system may issue an alert or notification to a sales associate, asking them to offer alternatives to the customer, such as pre-packaged products, home delivery or a later pick-up time.

In other embodiments, the current staffing levels may exceed that needed based on the current order demand. Since the system knows staffing level and current order demand, an additional feature that is now available is the ability to assign the excess staff members to perform scheduled maintenance and hygiene procedures on the equipment. For example, the system may notify a fulfillment staff member to perform a procedure on a particular piece of equipment when that piece of equipment is due for scheduled maintenance or cleaning, and there is enough reserve capacity to deliver product. The system may even redirect orders to another piece of equipment during the process. In other embodiments, the system may inform the staff member to perform other duties, such as sweeping. In other embodiments, the system may also schedule breaks for the fulfillment staff, allowing staff members to take their break during times where the queue is short.

In addition to managing the human resources, the present system may be used to manage the inventory of the deli. For example, the system may be made aware of the amount of each food item currently resident in the deli (i.e. the initial inventory). As orders are placed and serviced, the system may estimate the total remaining inventory based on the amount of each item consumed by each order. As the current inventory of one or more items drops below a predetermined threshold, the system may notify the staff or order administration of the need to replenish that item. Thus, rather than manually reviewing the inventory periodically to determine ordering needs, the system can be queried and will provide an estimate, based on actual orders, of the inventory. In other embodiments, the system may generate an inventory report periodically.

As an example, suppose that salami from a particular supplier is delivered in 3-pound sticks. Initially, the system is made aware that the deli currently has 5 sticks of that item. As customers place orders for that particular brand, the system deducts the weight of the order from the total amount of salami remaining. As that total amount of salami in the deli drops below a particular threshold, the system can notify staff. In another embodiment, the system can be queried at the end of the week (or any other time) and generate a report on the current inventory. In some embodiments, the system can be supplemented by fulfillment staff input. For example, when a staff member finishes one stick of salami, this information can be input into the system. This may correct some estimating inaccuracies in the computing of the inventory.

In some embodiments, the system can be used to analyze buying patterns or trends. For example, the system can readily compute the daily or weekly consumption of a particular food item. By comparing the consumption amount from one week to another, one can determine the effectiveness of a sale or other promotion. The system may also identify changes in buying behavior. For example, the system may determine that consumption of deli meats decreases in the summer (since children are not in school), based on orders placed over a certain period of time. Based on this, it may suggest a lower replenishment quantity of these food items than may be used at other times of the year.

In addition, the system can be used as a predictive tool. For example, since the system has information about every order that is placed, as well as the time each order is placed, it may make observations about past buying patterns. Based on this, it may be used to make predictions about future buying patterns. For example, the system may note a trend whereby more orders are placed between 3 and 4 PM in the afternoon. It may further note that roast beef and turkey are often ordered during this time period. In response to this observation, the system may proactively request these items, such as at a slow time period. This way, when the deli counter gets busy, as expected, previously sliced roast beef and turkey are already ready for use by the fulfillment staff. This predictive function can also analyze trends based on time of day, day of the week, month of the year, or any other function of time. In other words, the system may note that Monday is a exceptionally busy day, while Thursday are exceptionally light. Based on this, the system may proactively request items, such as roast beef and turkey, on Mondays, but not on Thursday. Similar analysis can be done for month of year.

In one embodiment, the system may request these items in common quantities, such as pound. In this way, if a customer orders of roast beef, or a multiple thereof, the item is already sliced. In some embodiments, the system maintains a list or record of pre-fulfilled items, such that it is able to notify a staff member that the requested item is already available.

In another embodiment, the present system may also aid the fulfillment staff by notifying them of the location of a particular food item. A layout of the deli may be input into the system so that it is aware of the location of each food item. In this way, training of new employees can be minimized as the system can assist with this task.

While the “back end” function described above includes fulfillment and delivery, these functions may be separate. Several methods of delivering orders to customers are anticipated. The traditional method of order delivery is to pick the order at the deli counter, either directly from the deli attendant or from an order pick-up slot. In this embodiment, the fulfillment and delivery functions may be provided by the same staff members.

A traditional order pick-up method can be used, but in one embodiment, it is enhanced by an “order ready” notification system. A customer can be notified that their order is ready for pick up. This may be accomplished via a text message or through a pager-type alert system such as those used when waiting for a table at a restaurant, that the customer receives at the time their order is placed. A device integrated into a shopping cart can also be used to inform the customer of a ready order. These examples of possible notification methods are illustrative only and not intended to enumerate all possible notification methods.

Alternately, a customer's completed order may be delivered to them within the store by an associate. If a tracking device such as that described previously is incorporated, this delivery method is enhanced, as it is easier for the associate to find the customer. Alternately, a flag or plackard containing an identifier may be placed on the shopping cart for visual identification.

As mentioned above, another alternative is to deliver completed orders to the checkout or cashier area. When the customer is ready to check out they can either collect their order from a central location, or it can be delivered to them while in line or checking out.

Furthermore, the notification system can also alert the cashier of customers who have orders that have not been delivered or picked up. When the customer is checking out, if they have forgotten to pick up their order, that order can then be delivered to them, avoiding the current problem of abandoned orders that are not picked up and paid for. Customers may be identified by a loyalty card number, tracking device or other means.

In any of these embodiments, the cost of the deli order could be automatically transferred to the customer's bill based on confirmation of their identity at time of ordering and at checkout, i.e. through a customer loyalty card or any other means.

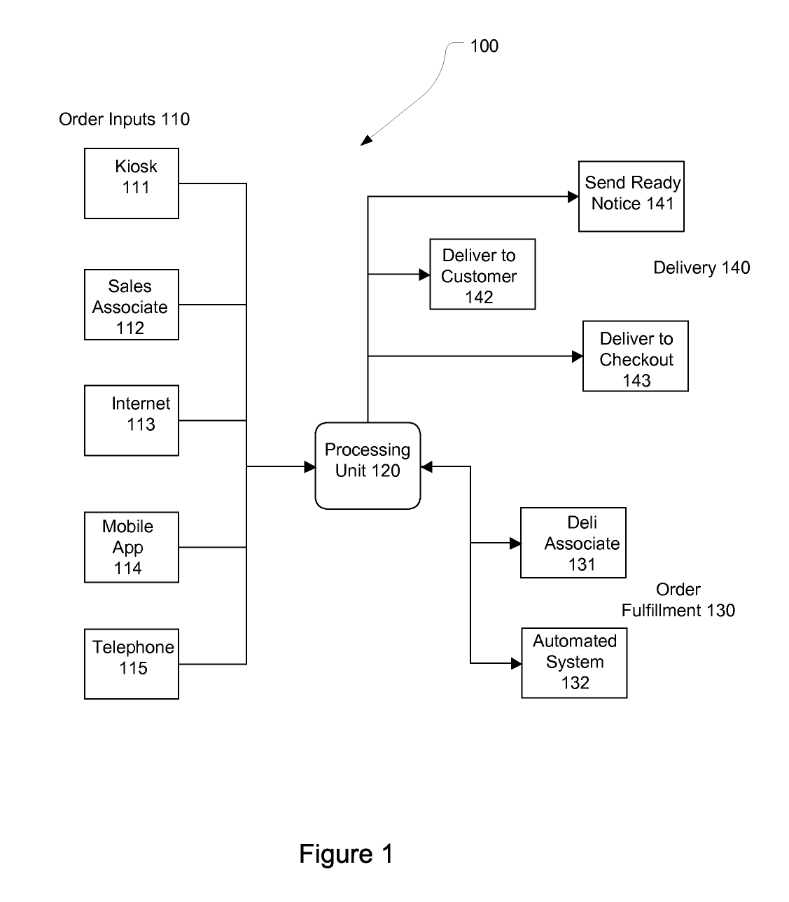

FIG. 1 shows a representative schematic flow chart for the management system 100. On the left side of the chart are examples of the order inputs 110. A customer inside the store may order using an in-store kiosk 111, or may talk with a sales associate 112, as is done currently. Customers outside of the store may order using the internet 113, a mobile device application 114, or call on a traditional telephone 115. As new communication technologies are developed, the system can be adapted to accept orders using them.

When the order is placed, certain information is entered into the system 100. The order entry data may include the desired items and quantity. The data may also include the desired pick-up time, estimated shopping time and whether the customer will wait at the counter for the order. The orders are then entered into the processing unit 120.

The processing unit 120 is programmed to calculate the estimated fulfillment time and compare it to the desired pick-up or completion time and current fulfillment workload. As stated above, the processing unit 120 may use past fulfillment data to estimate fulfillment times, or may use an estimation procedure.

The orders are then placed in a queue in an order that will most efficiently insure that they will be completed by the desired time. This order may be static in that once an order has been added to the queue, it is not adjusted by the processing unit again. In other embodiments, the processing unit may dynamically adjust the order of items in the list, based on changes to the desired completion time. For example, if the customer is returning to the deli counter earlier than estimated, the order may be reprioritized so that it is filled sooner.

The order at the top of the queue is then submitted to the order fulfillment function 130. In some embodiments, a deli associate 131 fulfills the order, much as is done today. Alternatively, an automated device 132 can receive orders for fulfillment. A combination of automated and manual fulfillment can also be managed by the processing unit 120 for maximum efficiency.

Once an order is completed by the order fulfillment function 130, the processing unit 120 is notified that it is ready for delivery. The processing unit 120 can invoke the delivery function 140. The delivery function may then send a notice 141 to the customer that their order is ready using a text message, pager or other method. Alternatively, an associate can be directed to deliver the order to a customer 142 either waiting at the deli counter or to a location in the store as detected by a location device. In some embodiment, the fulfilled order is delivered to a central checkout location 143.

It should be noted that, while FIG. 1 shows a single processing unit, the invention is not so limited. For example, a first processing unit may be used to communicate between the customer inputs 110 and the order fulfillment function 130. A second processing unit may be used to interface between the order fulfillment 130 ad the delivery 140 functions. In other embodiments, the order fulfillment 130 and delivery 140 functions are performed by the same staff person. For example, the deli associate 131 may deliver the order to the customer 142.

As orders are filled, they are removed from the queue. As new orders are entered, the processing unit 120 places them in the queue in the proper location and, if necessary, rearranges other orders within the queue for maximum efficiency and timely delivery. If, using a tracking device or other method, it is deemed that an order's delivery time has changed, the system dynamically rearranges the queue for prompt and efficient delivery. Furthermore, as described above, certain orders can be given higher priority, such as those of loyal customers.

As described above, the queueing and management system is controlled by a processing unit 120. This unit 120 may be a stand alone computer, such as a personal computer (PC) or specially designed computing device. In other embodiments, the processing unit 120 is a part of the facility's central computer system.

The processing unit 120 includes a processor, an input device capable of receiving orders using one or more methods described above. In addition, the processing unit has a memory element, which may be volatile or non-volatile. Instructions that can be executed by the processor are stored in the memory element. These instructions allow the processing to create and maintain the queue structure described herein. In addition, these instructions allow the processor to estimate fulfillment time of a particular order, and may include notification means. The instructions executed by the processor may be written in any suitable computer language. Furthermore, a portion of the memory element may be used for volatile information. For example, the actual queue structure and entry form data may be stored in the same memory element as the instructions. In other embodiments, the queue structure and entry form data is kept in a separate memory element, also accessible by the processor.

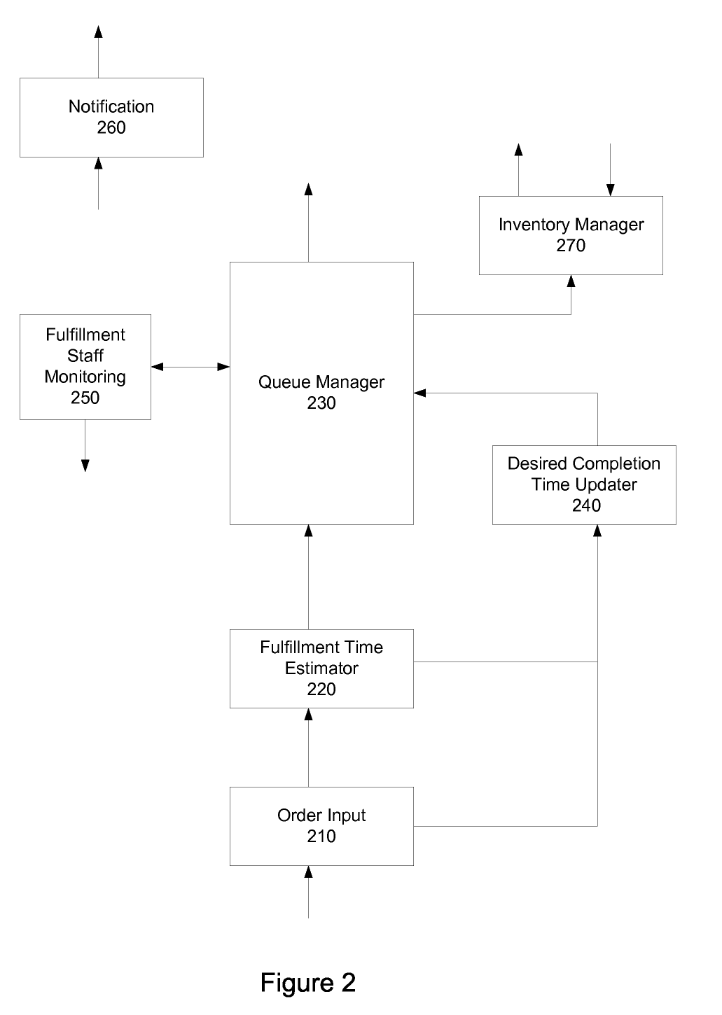

FIG. 2 shows a representative schematic of the software modules used in the present invention. These modules may be resident in the memory element described above. Order information is accepted by the Order Input module 210. This module accepts input from any of the sources shown in FIG. 1. This module then creates an order entry form, which includes the order information, order identification number, customer loyalty information, an initial desired completion time and the method by which the desired completion time is to be determined. For example, if the customer enters the order via a kiosk and continues to shop, a tracking device may be associated with the order. In other embodiments, if the customer waits at the counter, there is no need to update the desired completion time, as the customer is waiting and likely wants their order serviced as soon as possible.

Information from the order input module 210 is supplied to the fulfillment time estimator 220. The fulfillment time estimator 220 looks at the number and quantity of items contained in the order and using some estimation technique, calculates an estimated fulfillment time. The desired completion time and the estimated fulfillment time are then used by the queue manager 230 to properly insert the new order into the queue.

Items inserted in the queue may be single or double linked, as deemed appropriate by the implementer. The queue manager 230 finds the position in the queue where the new order should be placed, based on the estimated fulfillment time and the desired completion time. Other parameters, such as customer loyalty information, may be used to determine the position of the new order in the queue. In some embodiments, as described above, more than one queue may be used, such as an Order and Item queue. The queue manager 230 is intended to manage all such queues. It should be noted that the software modules used to manage each queue may be separate, communicating relevant information between them. In other embodiments, all queues are managed by a single software module.

In some embodiments, a Desired Completion Time Updater 240 is also used. As stated earlier, in some embodiments, the desired completion time can change due to the customer's location or other factors. In one embodiment, the Order Input module 210 or the Fulfillment Time Estimator 220 supplies parameters of the new order to the Desired Completion Time Updater 240. For example, the serial number or frequency of the tracking device associated with a particular order may be supplied to the Estimator 240. In other embodiments, the mobile telephone number of the customer may be supplied to the Estimator 240. The Estimator 240 can then monitor the movement of the customer and recalculate the completion time. This recalculation can be continuous or at discrete time intervals. If the Updater 240 calculates a completion time that is different than that currently being used by the Queue Manager 230, the Updater 240 will interact with the Queue Manager 230 to re-position the order within the queue. In some embodiments, the difference between the calculated completion time and that being used by the Queue Manager 230 must exceed a predetermined threshold before the Updater 240 will attempt to re-position the order.

When an order reaches the top of the queue, the order information is then passed to the fulfillment function. In some embodiments, a staff member receives an itemized list of items. In other embodiments, an automated mechanism is used to fulfill the order.

In some embodiments, a Fulfillment Staff Monitoring module 250 is present. As described earlier, the Fulfillment Staff Monitoring module 250 can perform a variety of functions.

In some embodiments, it monitors the performance of the fulfillment staff and uses actual measured fulfillment times to update the estimating tool in the Fulfillment Time Estimator 220. In addition, this performance data can be generated as a report to inform management of average fulfillment times and highlight staff members whose performance deviates from the norm.

In some embodiments, the Fulfillment Staff Monitoring module 250 interacts with the Queue Manager 230 to interpret the current workload and estimated future workload. It then compares this workload information and trends to the current staffing level of the Fulfillment department. The fulfillment staff is defined as the group of personnel currently assigned to preparing orders for the customers. For example, in a deli department, the fulfillment department includes all personnel currently available to slice meat and cheese. In a seafood department, it may include all personnel available to weigh, wrap, and package fish products. If there is a discrepancy (i.e. too many or too few staff members to handle the expected workload), the module can alert the staff of the situation. In some embodiments, in addition to notifying the staff of the anticipated discrepancy, it can initiate corrective actions. For example, in the case of understaffing, the system may notify additional staff members, notify staff from other departments or delay breaks. In the case of overstaffing, the system may ask members to take their breaks, take equipment offline for hygienic cleaning, or notify staff members to undertake other tasks, such as sweeping.

In some embodiments, after fulfilling the order, the fulfillment function enters the order number (or other identifying information) into the Notification module 260. In some embodiments, the Notification module 260 uses the tracking device, pager or mobile device to alert the customer that the order is ready. In other embodiments, there is no notification module 260, as the fulfillment personnel also serve as the delivery mechanism.

In some embodiments, an Inventory Management module 270 may be employed. The module 270 may receive inputs fro the staff to determine initial inventory levels. The Inventory Management module 270 may communicate with the Queue Manager 230 as orders are processed so that it can continue to monitor the current inventory level of all food items in the deli. The Inventory Manager 270 may have the ability to notify staff when the quantity of a particular item drops below a predetermined threshold. In other embodiments, the Inventory Manager 270 may generate an inventory report, detailing the quantity of each food item. In another embodiment, the report would only identify items that need to be ordered.

It should be noted that the functions shown in FIG. 2 may be performed by one or more processors. Throughout this disclosure, the term “processing unit” is meant to denote any computational device or devices which are able to perform the functioned enumerated herein. For example, in some embodiments, all of the software modules shown in FIG. 2 are performed by a single processor. In other embodiments, these modules may be executed by separate processors, which communicate required information to one another using an inter-processor communication path, such as a shared memory, communications channel, register store or other mechanism.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes.

What is claimed is:

1. A queueing and management system for order fulfillment, comprising a processing unit and a memory element having instructions adapted to:
receive an order from a customer, and
prioritize the fulfillment of said order within a fulfillment queue based on the desired completion time of said order.

2. The queueing and management system of claim 1, wherein said desired completion time is estimated by said customer.

3. The queueing and management system of claim 1, wherein said desired completion time is estimated based on the location of said customer.

4. The queueing and management system of claim 3, further comprising a tracking device, configured to identify the location of said customer within a store.

5. The queueing and management system of claim 3, further comprising a mobile device configured to relay the location of said device to said processing unit.

6. The queueing and management system of claim 1, wherein the position of said order within said fulfillment queue is modified based on changes to said desired completion time.

7. The queueing and management system of claim 1, further comprising means of notifying said customer that said order has been fulfilled.

8. The queueing and management system of claim 4, further comprising means to deliver said fulfilled order to said customer, wherein said means interacts with said tracking device to find said customer.

9. The queueing and management system of claim 1, wherein said instructions are adapted to prioritize certain customers based on predetermined criteria.

10. The queueing and management system of claim 9, wherein said criteria comprises participation of said customer in a loyalty program.

11. The queueing and management system of claim 1 wherein said order may be received using a mechanism selected from the group consisting of telephone, internet, orally, and electronic kiosk.

12. The queueing and management system of claim 1, wherein said fulfilled order is delivered to a location at or near the checkout.

13. A method of fulfilling customer orders, comprising:
receiving an order from a customer, said order having a desired completion time;
using a processing unit to prioritize said received order based on said desired completion time in a queue with other previously received orders; and
fulfilling said order when said order reaches the top of said queue.

14. The method of claim 13, further comprising using a tracking device to monitor the location of said customer, updating said desired completion time based on the location of said customer, and reprioritizing said order in said queue based on said updated desired completion time.

15. The method of claim 14, wherein said tracking device is selected from the group consisting of a pager, cell phone or a device mounted to said customer's shopping cart.

16. A queueing and management system for order fulfillment, comprising a processing unit and a memory element having instructions adapted to:
receive a plurality of orders from a plurality of customers, wherein each of said orders comprises one or more items, and prioritize the fulfillment of said items in said orders so that items that are common to more than one of said orders are fulfilled consecutively.

17. The queueing and management system of claim 16, wherein said memory element comprises a first queue, adapted to hold the orders placed by said plurality of customers.

18. The queueing and management system of claim 17, wherein said memory element comprises a second queue, adapted to hold said items that comprise said orders in said first queue.

19. The queueing and management system of claim 18, wherein said items in said second queue are associated with orders in said first queue.

20. The queueing and management system of claim 19, wherein said processing unit is adapted to reprioritize items in said second queue such that like items occupy consecutive positions in said second queue.

21. The queueing and management system of claim 20, wherein each item in each order is given a unique identifier, thereby allowing each item to be associated with its respective order.

22. The queueing and management system of claim 21, wherein said system notifies a staff member if one or more items in the order at the top of said first queue have already been fulfilled.

23. A management system for fulfillment of orders, comprising a processing unit and a memory element having instructions adapted to:
receive a plurality of orders from a plurality of customers, wherein each of said orders comprising one or more items;
monitor the number and type of items ordered as a function of time;
predict future ordering trends, based on said monitoring; and
request the fulfillment of certain items based on said prediction, prior to a customer ordering said items.

24. The management system of claim 23, wherein said system requests said certain items to be fulfilled in common quantities.

25. The management system of claim 24, wherein said system maintains a list of said pre-fulfilled certain items, and notifies a staff member when a customer order includes an item that has been previously fulfilled.

26. A queueing and management system for fulfillment of orders, comprising a processing unit and a memory element having instructions adapted to:
receive a plurality of orders from a plurality of customers, wherein each of said orders comprises one or more items;
receive information concerning the staffing of the fulfillment department;
place said plurality of orders in a queue;
monitoring current order demand and said staffing level; and
identifying a discrepancy between said current order demand and the capacity of said current staffing level.

27. The queueing and management system of claim 26, wherein said system notifies appropriate personnel that said current staffing level is insufficient to handle current order demand.

28. The queueing and management system of claim 27, wherein personnel from a different department are added to said fulfillment staff.

29. The queueing and management system of claim 26, wherein said system notifies a member of said fulfillment department to perform a different function, if the current order demand is insufficient to require said current staffing level.

30. The queueing and management system of claim 29, wherein said member is instructed to clean a piece of equipment.

31. The queueing and management system of claim 29, wherein said member is instructed to go on break.

32. The queueing and management system of claim 29, wherein said member is instructed to go to a different department.

33. The queueing and management system of claim 26, wherein each of said orders comprises a desired completion time, and said system compares an estimated completion time, based on said current staffing levels, to said desired completion time to determine if said discrepancy exists.

34. A queueing and management system for fulfillment of orders, comprising a processing unit and a memory element having instructions adapted to:
receive a plurality of orders from a plurality of customers, wherein each of said orders comprising one or more items, and has a desired completion time;
estimate the fulfillment time of each of said plurality of orders; and
place said plurality of orders in a queue based on said estimated fulfillment time and said desired completion time.

35. The queueing and management system of claim 34, wherein said estimation is based on empirical data.

36. The queueing and management system of claim 35, wherein said system is adapted to monitor the fulfillment time of each of said items and update said estimated fulfillment times based on said monitored fulfillment times.

37. The queueing and management system of claim 34, wherein said system is adapted to monitor the fulfillment of each of said items and the identity of the fulfillment staff member fulfilling each of said items.

38. The queueing and management system of claim 37, wherein said system is adapted to generate a report detailing each staff member and their fulfillment times.

39. A queueing and management system for fulfillment of orders, comprising a processing unit and a memory element having instructions adapted to:
receive information concerning the initial inventory level of each of said items;
receive a plurality of orders from a plurality of customers, wherein each of said orders comprising one or more items;
place each of said plurality of orders in a queue; and
update said inventory level of an item as an order comprising said item is fulfilled.

40. The queueing and management system of claim 39, wherein said system is adapted to generate an inventory report, based on said initial inventory level and said updates.

41. The queueing and management system of claim 39, wherein said system is adapted to generate an indication that the inventory of said item is below a predetermined threshold.
